(19) United States
(12) Patent Application Publication
(10) Pub. No.: US 2007/0055592 A1
(43) Pub. Date: Mar. 8, 2007

(54) Fully automated payroll data processing system using GUI worked time recorder

(76) Inventor: Quyen T. Vu, Missouri City, TX (US)

Correspondence Address: Quyen T. Vu, 4022 Silver Ridge Blvd., Missouri City, TX, 77459, US

(21) Appl. No.: 11/201,362

(22) Filed: Aug. 10, 2005

(51) Int. Cl. G07C 1/10

(52) U.S. Cl. 705/32

(57) ABSTRACT

This invented single PC payroll software, operating on a single PC, introduces an invented computerized payroll method which allows one to perform a complete payroll processing task without the need of an external worked time recorder and an intermediate data transferring device used by the traditional computerized payroll method. The said invented single software integrates the invented GUI Employee Worked Time Recorder and the invented Payroll Data Processing module into a single fully automated payroll data processing system running on a single PC which allows employee(s) or authorized person(s) using a mouse to clock in/clock out employee worked times. The system then categorizes employee worked times into different types of paid hours (regular, overtime, shift, weekend, service, etc.) based on the preset work-hour and pay-rate rules applicable to each employee; and thence, the system automatically generates employee payroll checks, payroll reports, and payroll-related tax forms.

### CROSS-REFERENCE TO RELATED APPLICATION

U.S Patent Documents

| | | |
|---|---|---|
| 5,717,867 | Feb. 10, 1998 | Wynn et al. |
| 4,812,627 | Mar. 14, 1989 | Wexler et al. |
| 4,819,162 | Apr. 14, 1989 | Webb, Jr. et al. |
| 5,459,657 | Oct. 17, 1995 | Wynn et al. |
| 4,658,357 | Apr. 14, 1987 | Carroll et al. |

### REFERENCE TO SEQUENCE LISTING, A TABLE, OR A COMPUTER PROGRAM LISTING COMPACT DISC APPENDIX

“Not Applicable”

### BACKGROUND OF THE INVENTION

1. Field of the Invention

The present invention is to create a Single Fully Automated Payroll Data Processing System operating on a PC. The invented system integrates the two traditionally “separate systems of the payroll process,” namely: the “employee worked time recording” system and the “payroll data processing” system into single PC application software that can concurrently perform two functions: employee-worked-time recording and payroll-data processing.

2. Description of the Related Technology

Presently, the traditional payroll processes can be categorized into two main groups by two commonly used, the “manual payroll” method and the so-called “computerized-front-end payroll” method.

The “Manual-Payroll Method” System: Today, most small businesses are still using the manual-payroll method. In this method, the employees' worked times are recorded by using a daily time log, a mechanical time clock (to punch employees' time-slip), or like devices. The employees' worked-time records are then manually entered into the employee timesheets; finally, the timesheets are handed to a payroll bookkeeper at the end of each payroll period for calculating and issuing payroll checks and payroll reports. This method requires a great deal of paperwork overhead such as reviewing employees' worked-time records, filling employee timesheets, and calculating payroll items such as gross pay, taxes withheld, deductions, accrued benefit hours, net pay, company payroll taxes, company contributions, etc. These burdensome tasks are time consuming and high service cost since too much human work involved.

The “Computerized-Front-End Payroll Method” System: This method commonly comprises three systems. {1) The first system, “employee worked-time recording” system, includes the external electronic timecard reader(s) (or like devices) for reading the employees' identification timecards (or similar devices) to record employees' worked times; or, alternately, the external computerized time-recorder(s) using keyboard-input to record employee worked times. (2) The second system is an “intermediate data transferring” device (e.g., a central computer) for transmitting the employees' worked-time data from the first system to a payroll-processing computer. (3) The third system, “payroll data processing” system, is the payroll-processing computer (the computer in which payroll software was installed). The output data of the second system (intermediate-data-transferring device) will be transferred to the said payroll-processing computer through some operating process by a computer operator (manually entering data, using software to import or download data, etc.). The payroll-processing computer then uses these transferring data to do payroll processing and to generate payroll checks and payroll reports.

Although the “computerized-front-end payroll method” system shows improvement in reducing payroll processing time and service cost over the traditional “manual payroll” method, it still has its own various drawbacks as follows:

(1) The highly overhead cost of purchasing and installation service of the external time-card reading device(s) and the “intermediate data transferring” device is not affordable for small businesses, especially, for those with ten or fewer employees.

(2) The said “employee worked time” recorder (e.g., time clock) does not provide a means for the authorized person (supervisor, for example) to correct instantly the employee clock in/clock out mistake, which is, happening frequently.

(3) The company's payroll liabilities can only be checked when the output data (employees' worked time) from the “intermediate data transferring” device were transferred (through an operating process) to the payroll-processing computer. The disadvantage of not having the capability to track the company liabilities instantly is a major drawback because real-time tracking company's payroll liabilities is an essential need, especially, for small business to control the company financial scenario.

(4) Since the employee's worked time data records from the “employee worked time recording” system is not immediate available for the payroll-processing computer, the said “computerized-front-end payroll method” system must have an “intermediate data transferring” device (e.g., central computer) for transmitting the data from the “employee worked-time recording” system to the payroll-processing computer. Moreover, this data transferring task must be operated by a computer operator (to manually enter, import or download by software, etc.) daily, or, at the end of each payroll period. The requirement of an “intermediate data transferring” device as well as the human involvement (computer operator) makes the said “computerized-front-end payroll method” system not a Single Fully Automated Payroll Data Processing system; therefore, this system is not a perfect ideal payroll processing system, especially, for small businesses.

### BRIEF SUMMARY OF THE INVENTION

This submitted invention introduces a computerized payroll method that overcomes the said drawbacks of the two said traditional payroll methods, the “manual payroll” method and the “computerized-front-end payroll” method, by integrating the invented GUI Worked Time Recorder and the invented Payroll Data Processing module into a Single Fully Automated Payroll Data Processing System operating on a single PC for small business or on multiple PC's terminals (multiple GUI Worked Time Recorders) directly connected to a server for larger business. The invention completely eliminates the need of (1) an external “employee worked-time” recorder and (2) an “intermediate data transferring” device, and thence, the human involvement in the aforementioned data transferring task. This invented single PC application software is composed of six basic components: General Operating GUIs, GUI Worked Time Recorder, Time Analyzing, Payroll Processing, Paycheck & Report Generating, and Printing.

(1) General Operating GUIs component is used for creating company profile and employees' profiles, editing employee timesheets, entering employee manual payments, opening and printing payroll checks, payroll reports and payroll related tax forms, etc.

(2) The GUI Worked Time Recorder component is the most important invented part of the invention. This component makes the invented system become a Single Fully Automated Payroll Data Processing system by eliminating the need of an external “employee worked-time” recorder (e.g., external time clock) and an “intermediate data transferring” device (e.g., central computer). The GUI Worked Time Recorder component allows employee to clock in/clock out his/her worked times by using a mouse to select his/her identification code & name which is displayed permanently on the PC's screen while the system is running; in addition, he/she is also allowed to submit a brief note to the authorized person (supervisor, for example), if needed, through the GUI Worked Time Recorder. The GUI Worked Time Recorder component is also a means for the authorized person to clock in/clock out worked times for employees or to access the Time Entry Editing GUI Menu (by entering authorization password) to edit or correct the employees' worked-time entries (recorded by clock in/clock out process).

(3) The Time Analyzing component task is to generate automatically employees' timesheets by categorizing the employees' worked-time records into different worked hour pay types (regular, overtime, weekend, holiday, shift, service, etc.) based on the company's preset worked-hour pay rates and pay rules (configurable by using GUI).

(4) The Payroll Processing component's task is to process employees' timesheets and employees' manual payment entries (bonus paid, commission paid, for example) to generate the payroll records such as gross pay, taxes withheld, payroll deductions, net pay, accrued benefit hours, company payroll taxes, company benefit plan contributions, etc. This Payroll Processing component has direct access to the employee worked hours and manual payment records; therefore, the company can check its payroll liabilities at any instant by running payroll preprocessing.

(5) The Paycheck & Report Generating component's task is to access the payroll records to generate automatically employee payroll checks for each payroll period, payroll reports (Worked Hour Report, Payroll Tax Details Report, Federal Tax Report, State & Local Tax Report, Payroll Expense, etc.) and payroll related tax forms (Form 941, Form 940, Form 940-EZ, Form W-2, Form W-3, Form 1099-Misc, and Form 1096) for a selectable date range. This component, with its direct access to the real time payroll records, allows the company to track its payroll liabilities at any time. Especially, this component offered the capability to customize the generated report: the generated report's appearance can be customized on the fly by selecting the reporting payroll items (displayed as the check boxes on the report menu), the colors of the report, and the appearance of the report title.

(6) The Printing component task is formatting the said generated payroll checks, payroll reports, and payroll related tax forms to the appropriate real forms and sending them to the printer for printing.

### BRIEF DESCRIPTION OF THE DRAWING

The patent or application file contains at least one drawing executed in color. Copies of this patent or patent application publication with color drawing(s) will be provided by the Office upon request and payment of the necessary fee.

The color drawings in this document are the real pictures of the invented software's GUIs and they are used for examination purposes only.

FIG. 1 is the diagrammatic overview of the invented PC application software operating on a single PC. The diagram shows the hardware part (a PC), the basic components of the software along with their functionalities, and the internal data flow.

FIG. 2 is the picture of the invented GUI, named GUI Worked Time Recorder, appearing on a PC terminal (screen), a means for employees to clock in/clock out their worked times or authorized person to clock in/clock out employees' worked times.

FIG. 3 shows the picture of the Employee Login Menu (GUI), opened by the Today Date Label component of the GUI Worked Time Recorder, a means for the authorized person to select employee timecard or timesheet for editing or correcting employee worked time entries.

FIG. 4 is the picture of The Time Entry Editing menu (GUI), a means for opening employees' worked time records.

FIG. 5 is the picture of the Timecard Edit menu (GUI), a means for selecting an employee worked time entry record to add, update, or delete the entry.

FIG. 6A is the picture of the Update Entry menu (GUI), a means for updating employee's worked time entries.

FIG. 6B is the picture of the Add Entry (GUI), a means for adding new employee's worked time entries to the system.

FIG. 6C is the picture of the Delete Entry (GUI), a means for deleting employee's worked time entries from the system.

FIG. 7 is the picture of the Confirm Operation dialog box for employee to confirm his/her work-type (regular or service).

FIG. 8 is the picture of The Time Clock Configuration menu (GUI), a means for setting a rounding time or trimming time rule for the GUI Worked Time Recorder.

FIG. 9 is the picture of the Company Benefit GUI template, a means for entering company's offered benefits, pay-types, work-hour rules, etc. into the system.

FIG. 10 is the picture of the Employee Earning GUI template, a means for entering employee's pay rates and lunch time deduction rule into the system.

FIG. 11 is the picture of a Timecard report generated automatically by the system.

FIG. 12 is the picture of an employee timesheet generated automatically by the system.

FIG. 13 is the picture of Employee General GUI template, a means for entering employee's general information into the system.

FIG. 14A is the picture of a dynamic Payroll Tax Report showing the selected item check boxes and the displayed item columns.

FIG. 14B is the picture of the Payroll Tax Report (FIG. 14A) after deselecting State Tax and SUT Tax items.

FIG. 14C is the picture of the Payroll Tax Report (FIG. 14B) after deselecting all payroll items and reselecting State Tax and SUT Tax items.

FIG. 15A is the picture showing a report before changing the column-header's color and the color changing tools (Color Box & Column Header Color Picker).

FIG. 15B is the picture of the report (FIG. 15A) after changing the column header's color.

FIG. 15C is the picture showing the changing of the report's background color

FIG. 15D is the picture showing the changing of the report's odd rows' color.

FIG. 16A is the picture of the Report Printing Setup menu.

FIG. 16B is the picture of the report's appearance based on the setup shown in FIG. 16A.

FIG. 16C is the picture showing another Report Printing setup.

FIG. 16D is the picture of the report's appearance according to the setup shown in FIG. 16C.

FIG. 17 is the diagrammatic overview of the Single Fully Automated Payroll Data Processing software operating on multiple PCs (GUI Worked Time Recorders) directly connected to a server.

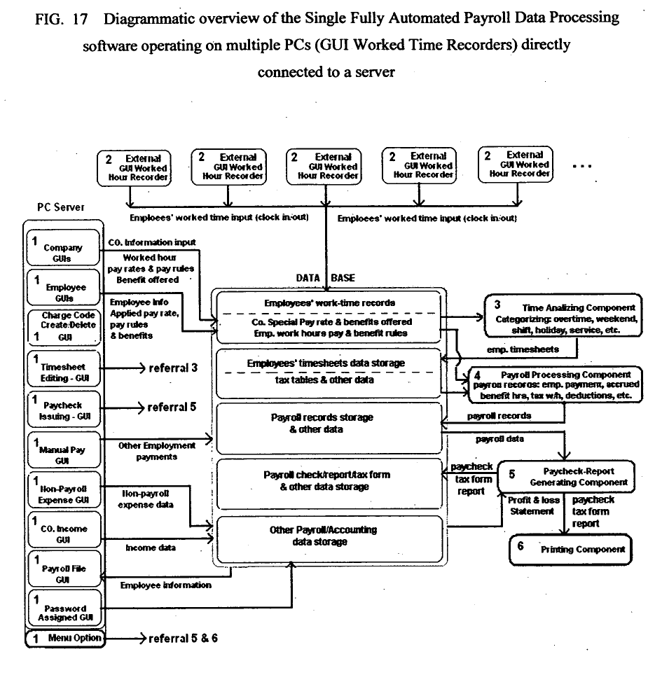

### DETAILED DESCRIPTION OF THE INVENTION

### System Overview

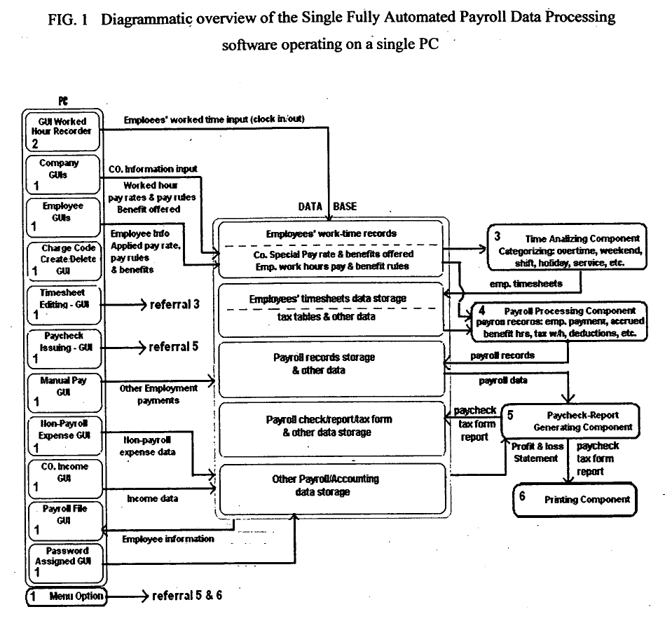

FIG. 1 is a diagrammatic overview of the invented Single Fully Automated Payroll Data Processing System (without the need of using any external Employee Worked Time Recorder and intermediate data transferring device) operating on a single personal computer. In term of hardware, the system requires a personal computer to run the said invented software. The diagram in FIG. 1 shows the six basic integral components (indicated by the referral numbers) of the invented software: General Operating GUIs, GUI Worked Time Recorder, Time Analyzing, Payroll Processing, Paycheck & Report Generating, and Printing component. The general description of these components such as their functionalities, their data accessing and sharing in the same system's database, and the basic operating procedure will be followed the order of the referral numbers on the diagram.

(1) The General Operating GUIs component (referral number 1s in FIG. 1): The utilization of the invented Single Fully Automated Payroll Data Processing System begins with building company profile (using Company GUIs) and creating employee profile (using Employee GUIs) for each employee. Other General Operating GUIs are used to enter data into the system and to open employees' payroll check GUIs, company's payroll report GUIs, payroll related tax form GUIs, etc. for editing or printing. The brief description of the General Operating GUIs is as follows:

(a) The Company GUIs are used to enter into the system company general data (company name and address, FEIN, State ID, etc.), payroll taxes data (FUTA, SUI, Local tax, etc.), benefit offered data (health insurance, salary reduction plan, etc.), special pay rate and worked hour rules data (overtime, weekend, holiday, shift, service, etc.). These preset data will be saved directly to the system's database. Note that the government tax rule data (Federal, states, and local tax tables, withholding rules, etc.) are stored into the system's database by the software.

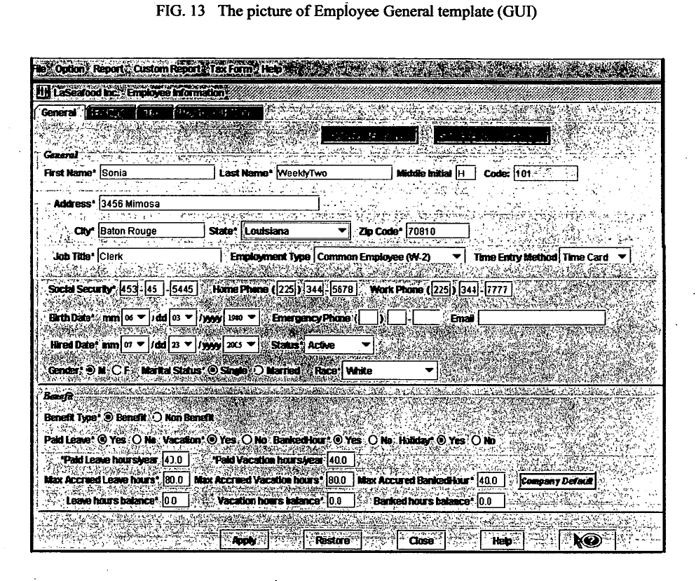

(b) The Employee GUIs (one of them is the Employee General GUI Template as shown in FIG. 13) are used to enter into the system employee's payroll-related data (name, address, social security number, time entry mode—hourly, timesheet, or salary—, tip earning status, payroll period, tax withholding data, applied worked hour pay rates and pay rules, applied benefits, etc.). These preset data will be saved directly to the system's database.

(c) The Charge Code GUI is used to create a new Charge Code (work type and pay rate) adding to the system or to delete the existing one from the system.

(d) The Timesheet GUI is used to open employee timesheets for editing, correcting, or printing.

(e) Paycheck GUI is used to open employee payroll check for editing, correcting, approving, or printing.

(f) Manual Pay GUI is used to enter into the system employee manual payments such as bonus paid, commission paid, etc.

(g) Income and Expense GUIs are not relate to payroll; however, these GUIs are big help for small business to record its incomes and non-payroll expenses to the system. The system will combine these data with the generated payroll-expense data to generate automatically the company's Profit & Loss Statement.

(h) Payroll File GUI is used to check employees' information such as employee code, name, social security, job title, and payroll period, and to check company's charge code information such as charge code name, description, pay type, period apply, effective date, and expired date.

(i) Password GUI is used to assign or change password for timesheet employee, supervisor, etc.

(j) Option Menu GUIs: A plurality of Option Menus interacting with the Paycheck & Report Generating Component are used to open company's payroll reports (Timecard report, Work Hours report, Period Summary report, Tax Exempted Wages report, Uncollected Taxes report, Uncollected Insurance Deductions report, Labor Expenses report, Benefit Plan Expenses report, Manual Payments report, Reported Tips report, Non-Payroll Expenses report, Incomes report, Profit & Loss Statement) and the Custom Reports—the payroll items displayed on the report are not fixed but configurable by selecting the reporting payroll items to be displayed—such as Federal Tax Withheld report, State & Local Taxes Withheld report, Tax Summary report, Payroll Tax Details report, etc. Other Menu Options are used to access generated payroll related tax forms which include Form 941, Form 940, Form 940-EZ, Form W-2, Form W-3, Form 1099-Misc, and Form 1096 for editing or printing.

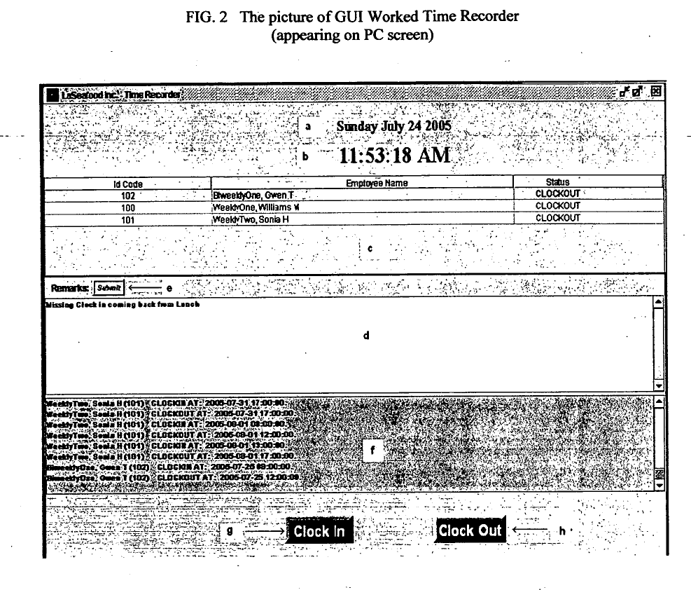

(2) The GUI Worked Time Recorder Component (referral number 2 in FIG. 1, and FIG. 2): This component is the most important invented part of the invention. This component makes the invented system become a Fully Automated Payroll Data Processing system by eliminating the need of using an external “employee worked time” recorder (e.g., time clock) and an “intermediate data transferring” device (e.g., central computer). The GUI Worked Time Recorder allows employee to clock in/clock out his/her worked times using a mouse to select his/her identification code & name which is displayed permanently on the PC screen while the system is running; in addition, he/she is also allowed to submit a brief note to the authorized person (supervisor for example), if needed, through the GUI Worked Time Recorder. The GUI Worked Time Recorder component also permits the authorized person (by entering authorization password) to clock in/clock out worked times for employees or to access the Time Entry menu to edit or correct employees' worked time entries recorded by clock in/clock out process. The worked time data (recorded by clocking in/out process) and the time entry data corrected by the authorized person are stored directly into the system's database. The employee's brief note, if any, will be displayed on the GUI Worked Time Recorder's display panel.

(3) The Time Analyzing Component (referral number 3 in FIG. 1): This component reads the employee worked time recorded data and the company preset worked hour pay rates and pay rules data applicable to each employee from the system's database. Based on these data, the Time Analyzing Component measures, analyzes, and categorizes the employee worked time records to the applicable worked hour pay types (regular, overtime, weekend, holiday, shift, service, etc.); and then generates automatically the employee timesheet. The employee timesheet is then stored directly into the system's database.

(4) The Payroll Processing Component (referral number 4 in FIG. 1): This component has direct access to the system's database to get the employee timesheet data, other payroll related data (employee tax filing status, payroll deductions, Federal and state tax tables, accrual benefit, etc.), and employee manual-payment entries (bonus, commission, for example) from the system's database to perform payroll computation to generate into the payroll records which include gross pay, taxes withheld, payroll deductions, net pay, accrued benefit hours, company payroll taxes, company benefit plan contributions, etc. The output payroll records from this component are stored directly into the system's database. This payroll processing component has direct access to the employee worked time and manual payment records; therefore, the company can check its payroll liabilities at any instant by running payroll preprocessing.

(5) The Paycheck & Report Generating Component (referral number 5 in FIG. 1): This component reads the payroll records stored in the system's database to generate payroll checks for each payroll period, payroll reports (Worked Hours report, Payroll Tax Details report, Federal Taxes Withheld report, State & Local Taxes Withheld report, Payroll Expenses report, Reported Tips report, Uncollected Taxes Report, Non-payroll Expenses report, Incomes report, Profit & Loss Statement, etc.) and payroll related tax forms (Form 941, Form 940, Form 940-EZ, Form W-2, Form W-3, Form 1099-Misc, and Form 1096) for a selectable date range. The generated paychecks, reports, and payroll-related tax forms are then stored directly into the system's database. This component, with its direct access to the real time payroll records, allows the company to track its payroll liabilities at any time. Especially, this component offered the capability to create dynamic customized report; the generated report's appearance can be customized on the fly by selecting the reporting payroll items (displayed as the check boxes on the report menu), the colors of the report, and the appearance of the report title.

(6) Printing Component (referral number 6 in FIG. 1): This component reads the generated payroll checks, generated payroll reports, and generated payroll related tax forms from the system's database to format them to the appropriate real forms and sending them to the printer for printing.

### GUI Worked Time Recorder

Referring to FIG. 2, this component is the most important part of the invention. This component makes the invented system become a Fully Automated Payroll Data Processing system by eliminating the need of the external Worked Time Recording system (which includes the external employee worked time recorder(s) and the intermediate data transferring device). The GUI Worked Time Recorder is designed as a real time-clock displayed on PC screen and operated by a graphical user interface (GUI) which allows employees to clock in their arriving time (for regular work) or start time (for service work) and clock out their leaving time (for regular work) or completing time (for service work) by using a mouse to select his/her identification code & name which is displayed permanently on the PC screen while the system is running. This GUI Worked Time Recorder also provides an on-screen panel for employees to submit a brief note to the authorized person (supervisor, for example), if needed. The authorized person can view all the submitted notes by right click on the Remark window and select the Display option. In addition, the GUI Worked Time Recorder also provides the means for the authorized person to clock in/clock out worked times for employees or to access the Time Entry menu (by entering authorization password) to edit or correct employees' worked time entries (recorded by clock in/clock out process). The GUI Worked Time Recorder records employee worked-time entries directly to the system's database; hence, the worked time data are instantly accessible by the Time Analyzing component and other components of the integrated system. The details description of the GUI Worked Time Recorder's controlling and operating functions is as follows:

(1) Internal Data Flow: Returning to FIG. 1, The employee worked-time entries by clock in/clock out actions on PC screen (referral number 2 of FIG. 1) are stored directly into the system's database. The Time Analyzing component (referral number 3 of FIG. 1) gets its inputs from the system's database including employee's time entries, company preset worked hour pay rates and pay rules data applicable to each employee, and company preset time entry rule data (rounding time rule for example); this component then carriers out the task of measuring, analyzing, and categorizing the employee's worked time entries into the applicable work hour pay types (regular, overtime, weekend worked, holiday, shift, service, etc.). The output generated from this Time Analyzing component is automated employee timesheets which are stored directly into the system's database.

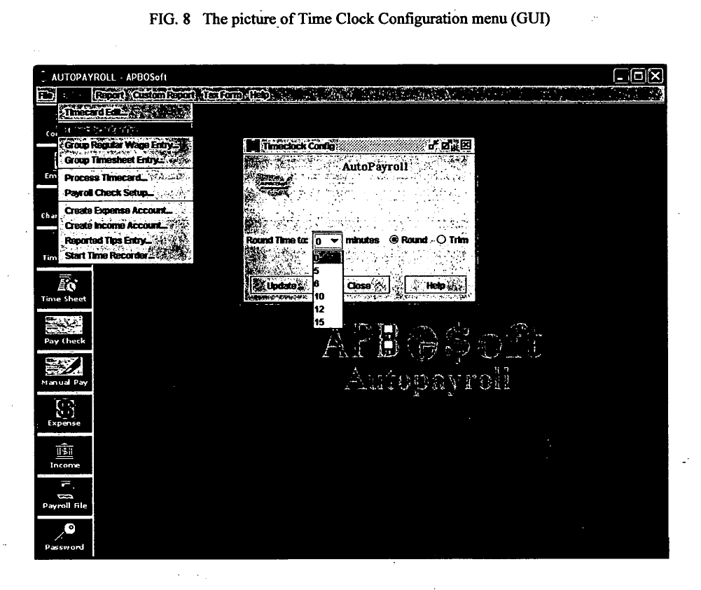

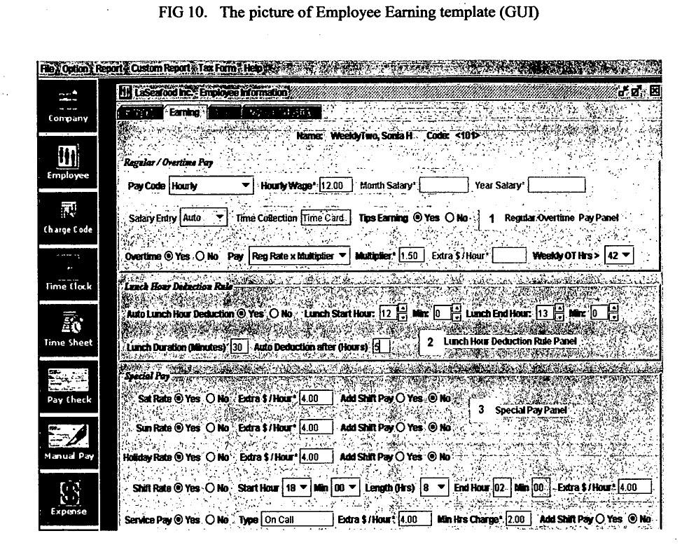

(2) Worked Time Recorder Configuration GUI (referring to FIG. 8): The GUI Worked Time Recorder can be configured to automatically round or trim time to the minutes resolution by selecting round or trim option and then choosing the minute resolution. In addition, as showed in referral number 2 of FIG. 10, the Lunch Hour Deduction Rule panel is used to set the “lunch time deduction” rule; the GUI Worked Time Recorder will automatically deduct the employee's lunch time according to this preset rule.

(3) Startup and Shutdown GUI Worked Time Recorder: To protect from unauthorized usage of the GUI Worked Time Recorder, only authorized person (with administrator password) can launch or shutdown the GUI Worked Time Recorder. To launch the GUI Worked Time Recorder, the authorized person must enter the administrator password to login into the said Single Fully Automated Payroll Data Processing System, and then select “Start Time Recorder” from the Option Menu. To shutdown the GUI Worked Time Recorder, the authorized person must select the Close button and then enter the administrator password into the Time Clock Shutdown dialog box.

(4) The GUI Worked Time Recorder Display Components: Referring to FIG. 2, the descriptions of the Display components (indicated by referral letter) of the GUI Worked Time Recorder and their functionalities are as follows:

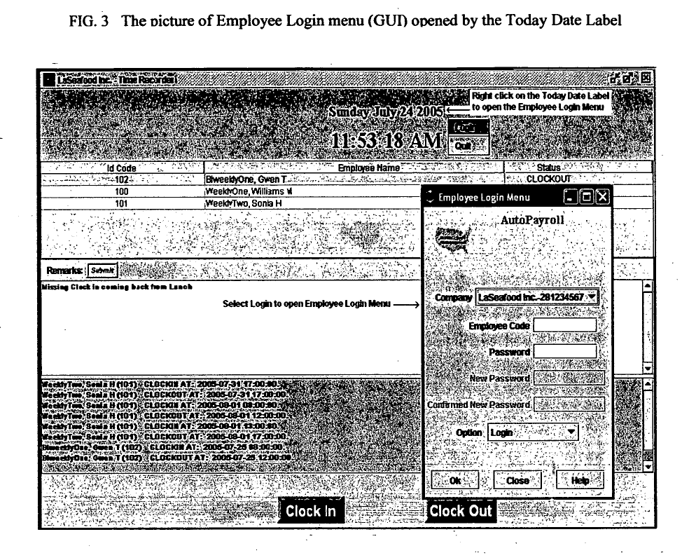

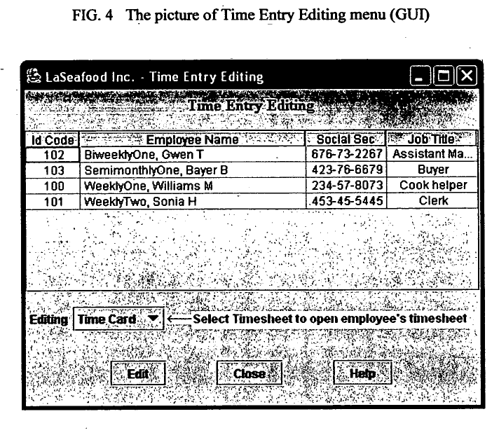

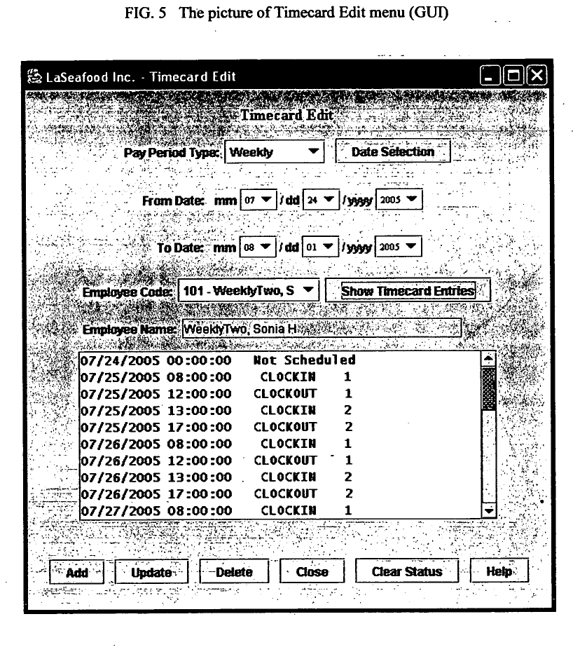

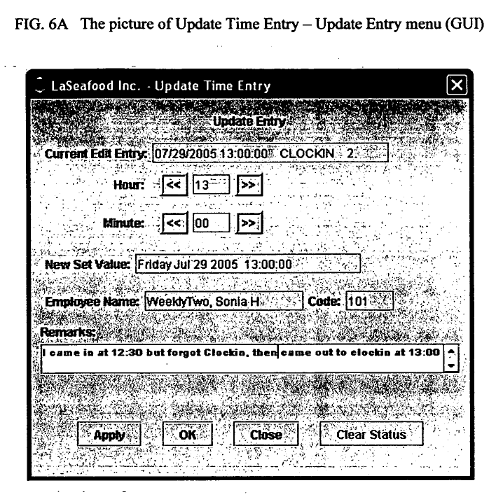

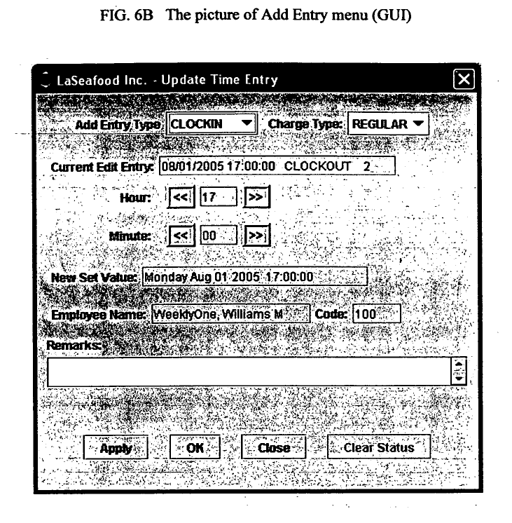

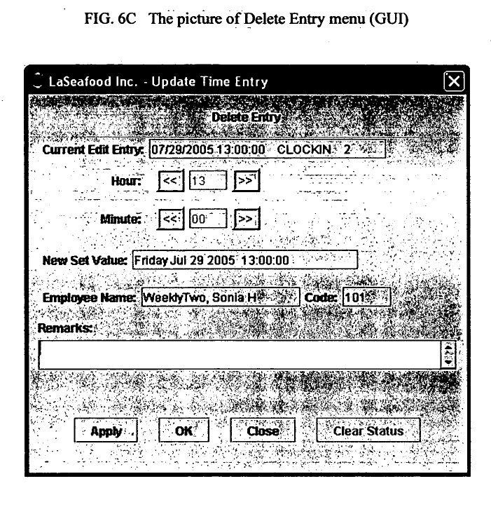

(a) The Today Date Label (referral letter a in FIG. 2): Besides the “displaying and maintaining of the current date” function, the Today Date Label is used as a login button (right click at the Today Date Label and select Login to open the Employee Login Menu as shown in FIG. 3) for authorized person (by entering authorization password) to open the Time Entry Editing menu (as shown in FIG. 4); and thence, from the Time Entry Editing menu, the authorized person can accesses the employee's timesheet or the employee's Timecard Edit menu (as shown in FIG. 5) to edit or correct the employee's worked-time entries (recorded by clock in/clock out process). The authorized person can update, add, and delete employee worked-time entries of a selectable date range by using the Update Time Entry submenus (GUIs); FIG. 6A, FIG. 6B, and FIG. 6C are the pictures of the Update Time Entry's submenus: Update Entry menu (GUI), Add Entry menu (GUI), and Delete Entry menu (GUI) respectively.

(b) The Clock (referral letter b in FIG. 2): The GUI Worked Time Recorder Clock displays and maintains the current time. The GUI Worked Time Recorder uses the PC system clock to display the current date and time; hence, in the case of the computer system is inadvertently shutdown, The GUI Worked Time Recorder remains on synchronized with the PC system clock when the system starts up again.

(c) The Employee Display List (referral letter c in FIG. 2): Only the timecard-employees, who are required to clock in/clock out their worked times, are displayed on the list. This type of worked time entry (Timecard type) is pre-selected when filling out data for the Employee GUI template to create the employee file. Each timecard employee is displayed on the list as a single record line which includes the employee code, employee name, and attendance status (Clock In, Clock Out, or none) of the current date.

(d) The Remark Panel (referral letter d in FIG. 2): This panel is used as a kind of notepad for employee to write a brief note of explanation about his/her “clock in/clock out” problem (forgetting to clock in on time, for example) to the authorized person in the case the authorized person cannot be contacted at the moment.

(e) The Submit Button (referral letter e in FIG. 2): This button is used to record (submit) the said employee's brief note (remark) to the system. The authorized person then can view all the submitted notes by right click on the Remark window and select the Display option.

(f) The Date & Time Record Panel (referral letter f in FIG. 2): This panel shows the employees' clock in and/or clock out date-and-time during the current payroll period.

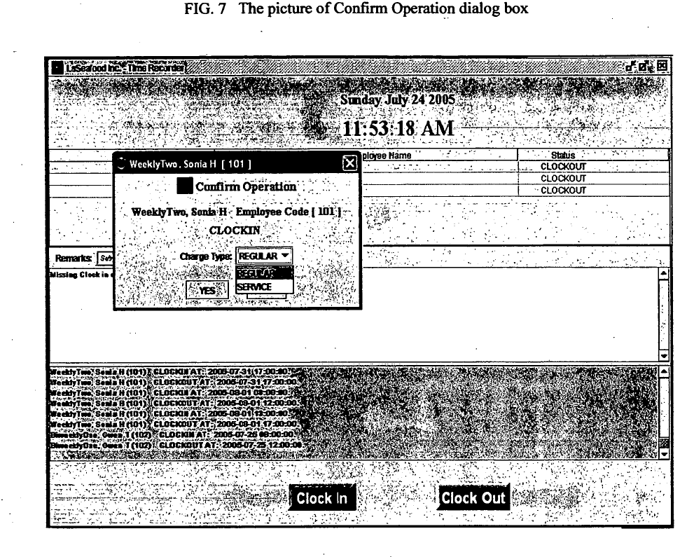

(g) The Clock In Button (referral letter g in FIG. 2): This functioned button is used to clock in employee's arriving time (for regular worked time) or starting time (for service worked time). The “clock in” process includes the following steps: (i) Select the employee's name & code, (ii) Click the Clock In button, (iii) Select the worked time type (Regular or Service) on the popped up Confirmation dialog (FIG. 7)—This selection of charge type is displayed if the employee has service-work which was pre-selected in the Employee GUI template. For other worked-time types (Overtime, Weekend, Holiday, Shift, etc.), the GUI Worked Time Recorder categorized them automatically based on the company's preset worked hour pay rates and pay rules applicable for each employee, (iv) Click Yes button in the popped up Confirm Operation dialog box to complete the “clock in” process. During the “clock in” process, the GUI Worked Time Recorder will reject the “clock in” action by popping up the error message if the employee's current attendance status is “clock in”. The GUI Worked Time Recorder also verifies the successful completion of the “clock in” process by showing the employee's “clock in” status in Status column and the employee's “clock in” date-and-time in the Date & Time Record panel.

(h) The Clock Out Button (referral letter h in FIG. 2): This functioned button is used to clock out employee's leaving time (for regular worked time) or completing time (for service worked time). The “clock out” process includes the following steps: (i) Select the employee's name & code, (ii) Click the Clock Out button, (iii) Click Yes button on the popped up Confirmation dialog box to complete the clock out process. During the clock out process, the GUI Worked Time Recorder will reject the “clock out” action by popping up the error message if the employee's current attendance status is “clock out”. In addition, if the employee's “clock in” time is in one day and the “clock out” time falls on the next day or in other later date, and then if the employee's “Clock In-Clock Out” time span is within 24 hours work-hour range, the GUI Worked Time Recorder will pop up the Confirmation dialog box to confirm if he or she is working night ship; In this case, the employee confirms his/her late shift work by clicking OK button to complete the clock out process. On the other hand, if the employee's “clock in-clock out” time span is more than 24 hours, the GUI Worked Time Recorder will pop up the error message to reject the “clock out” action; In this case, the employee must see the authorized person for correcting or approving his or her worked-time entry. The GUI Worked Time Recorder also verifies the successful completion of the “clock out” process by showing the employee's “clock out” status in Status column and the employee's “clock out” date-and-time in the Date & Time Record panel.

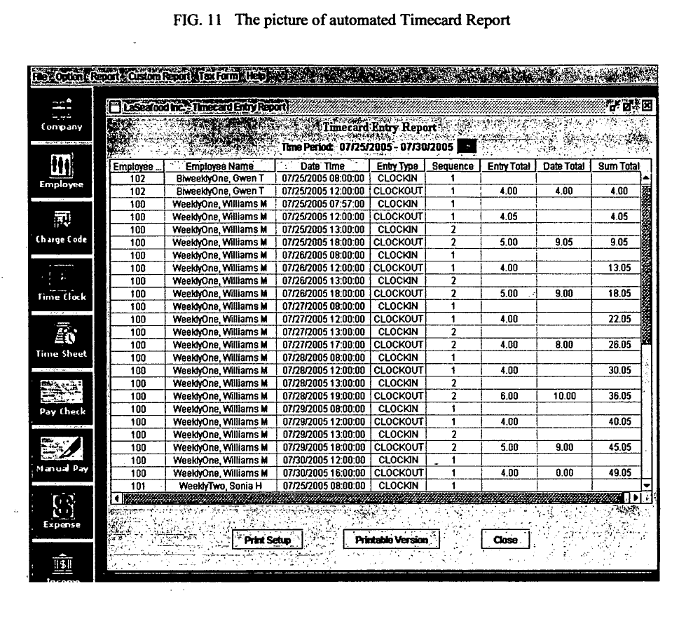

(5) Timecard Report: The GUI Worked Time Recorder records employee worked-time entries through clock in/clock out processes and stored them directly to the system's database. The time entry records can be displayed in the form of the Timecard Report as shown in FIG. 11; The Timecard Report displays the employee's code, name, “clock in/out” date-and-time, entry type (clock in or clock out), number of “clock in/out” in sequence, work-hours (“clock in-clock out” time span), total work-hours of each day, and the total work-hours of a selectable date range. The Timecard report can be opened by selecting Report Menu Option and then choosing Timecard Report.

### Time Analyzing Component

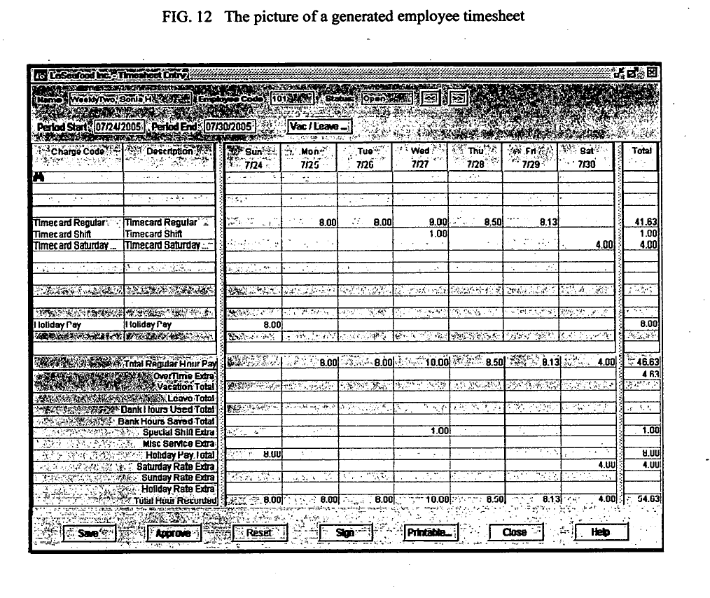

Referring to referral number 3 in FIG. 1, this components reads from the system's database the data relating to the company's worked hour pay rates and pay rules, and employee worked time entries (recorded by the GUI Worked Time Recorder); It then analyzes and categorizes the employee worked time records into the worked hour pay types (regular, overtime, weekend, holiday, shift, service, etc.) based on the rules set for each employee, and then automatically generates the employee timesheet (as shown in FIG. 12) and stores them into the system's database. The company's worked hour pay rates and pay rules are inputted into the system through the following GUI templates:

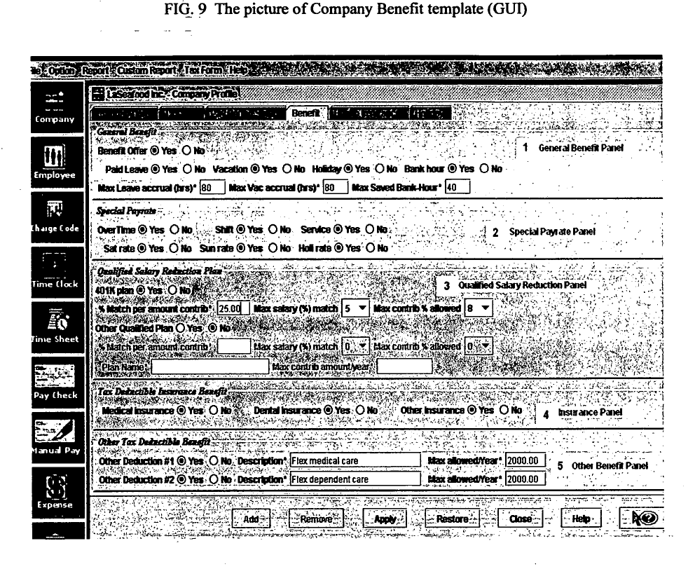

(1) Company Benefit Template GUI—Special Pay Rule Panel: Referring to referral number 2 of FIG. 9, any special pay rule selected in this panel will be saved directly to the system's database. Based on these data, the system (Single Fully Automated Payroll Data Processing System) will activate the applicable items in the Special Pay Panel inside the Employee Earning Template which is explained in next paragraph.

( 2) Employee Earning Template GUI—Special Pay Panel: Referring to referral number 3 of FIG. 10, any special-pay option selected and inputted pay rules and data in this panel will be saved directly to the system's database. Note that the system provides most generic pay types (regular, overtime, weekend, holiday, shift, service, etc.); however, a new pay type can be created and added to the system by using the Charge Code Setup GUI template.

### Payroll Processing Component

Referring to referral number 4 in FIG. 1, this component reads the employee timesheet data, payroll related data (employee tax filing status, deduction, Federal and state tax tables, tax withholding rules, accrual benefit, etc.), and employees' manual-payment entries (bonus, commission, for example) from the system's database to perform payroll computation to generate into the payroll records which include gross pay, taxes withheld, payroll deductions, net pay, accrued benefit hours, company payroll taxes, company benefit plan contributions, etc. The output payroll records from this component are stored directly into the system's database. This payroll processing component has direct access to the employee worked hours and other employee payment records; therefore, the company can check its payroll liabilities at any instant by running payroll preprocessing. The said payroll related data are entered into the system's database through the set of system's GUI templates; some of them are shown here along with their pictures as follows:
Company General Benefit Panel (referral number 1 of FIG. 9)
Company Salary Reduction Plan Panel (referral number 3 of FIG. 9)
Company Tax Deductible Insurance Benefit (referral number 4 of FIG. 9)
Company Other Tax Deductible Benefit (referral number 5 of FIG. 9)
Employee General data and Benefit panels as shown in FIG. 13

### Paycheck & Report Generating Component

Referring to referral number 5 in FIG. 1, this component reads the payroll records and others data stored in the system's database to generate employee payroll checks for each payroll period, company payroll reports (Worked Hour report, Payroll Tax Details report, Federal Taxes Withheld report, State & Local Taxes Withheld report, Payroll Expenses report, Reported Tips Report, Uncollected Taxes Report, Profit & Loss Statement, etc.) and payroll-related tax forms (Form 941, Form 940, Form 940-EZ, Form W-2, Form W-3, Form 1099-Misc, and Form 1096) for a selectable date range. The generated paychecks, reports, and payroll-related tax forms are then stored directly into the system's database. This component, with its direct access to the real time payroll records, allows the company to track its payroll liabilities at any time. Especially, this component offered the capability to customize the generated reports: the generated report's appearance can be customized on the fly by selecting the reporting payroll items (displayed as the check boxes on the report menu), the colors of the report, and the appearance of the report title. The Custom report will be explained more detail in section (VII).

### Printing Component

Referring to referral number 6 in FIG. 1, this component reads the generated payroll checks, generated payroll reports, and generated payroll related tax forms from the system's database to format them to the appropriate real forms and to send them to the printer for printing.

### Dynamic Reports

The appearance of the generated reports can be customized on the fly by selecting or deselecting the number of displayed item columns, selecting the colors of the report, and selecting the appearance of the report title. These selecting processes will be shown by the following sample Payroll Tax reports (the selecting process for other customized reports is exactly the same).

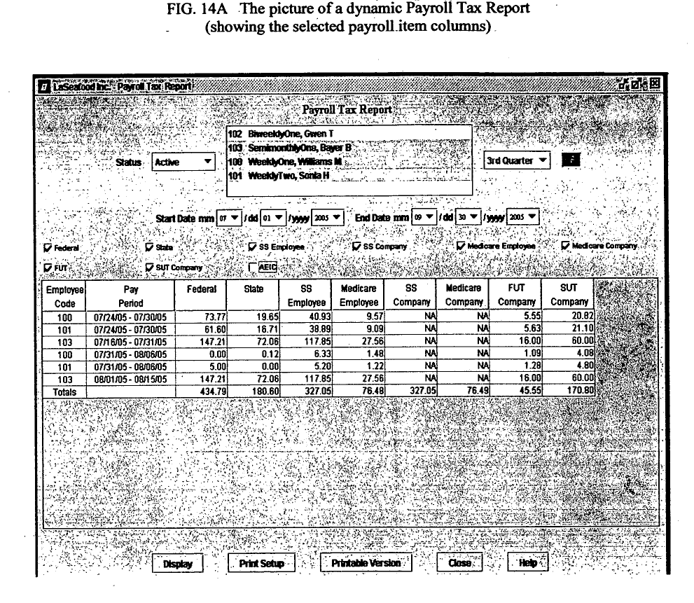

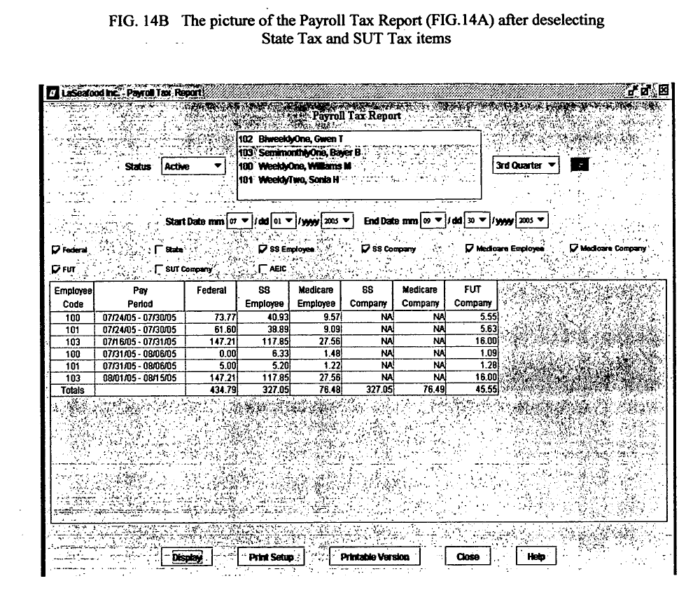

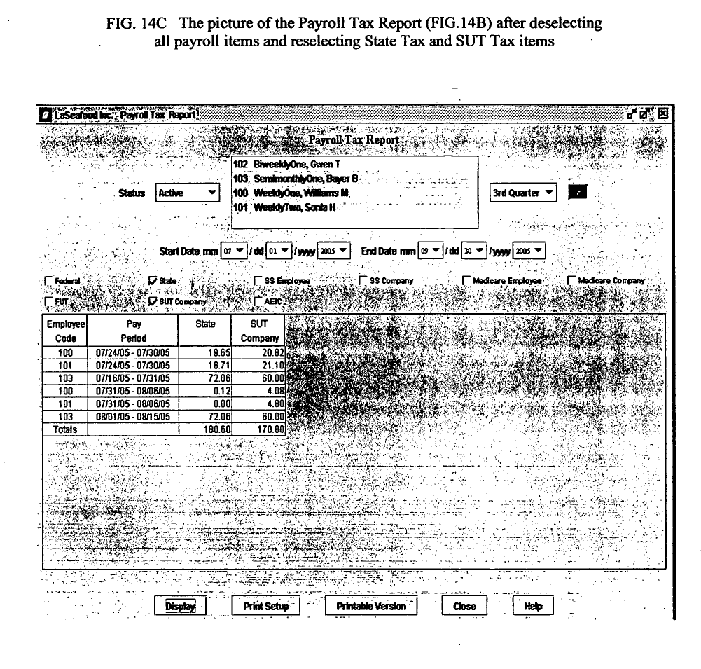

(1) Changing The Number of Displayed Item Columns: The generated report's appearance can be changed on the fly by selecting or deselecting the reporting payroll items displayed as check boxes on the report menu. Referring to FIG. 14A, the Payroll Tax report of the selected three active employees in the third quarter and the selected item check boxes were Federal Tax, State Tax, Social Security Tax Paid By Employee, Social Security Tax Paid By Company, Medicare Tax Paid By Employee, Medicare Tax Paid By Company, FUT Tax, SUT Tax. FIG. 14B is the appearance of the report (in FIG. 14A) after deselecting State Tax and SUT Tax items. FIG. 14C is the appearance of the report (in FIG. 14B) after deselecting all the report items and then reselecting State Tax and SUT Tax items.

(2) Changing The Color of The Report: The report's appearance can be changed on the fly by selecting the color for column header, background, “total amount” row, odd rows, even rows, and title. The following sample reports show the color changing process of the report's column header, background, and odd rows.

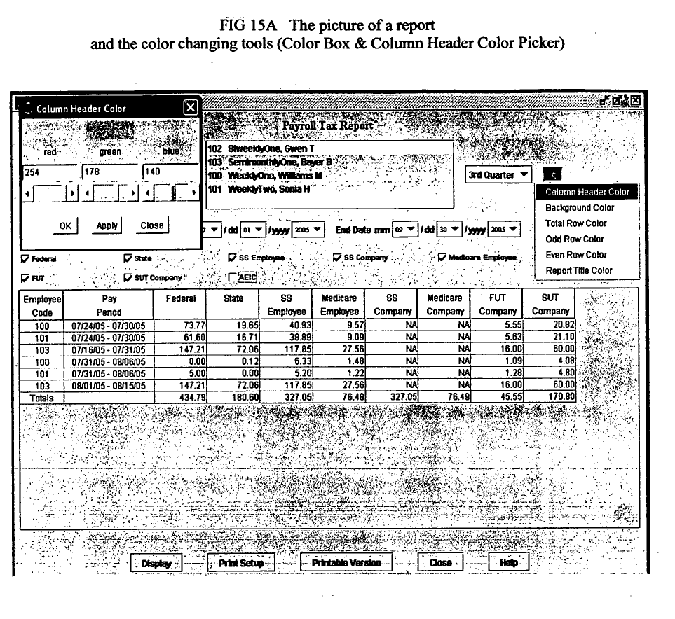

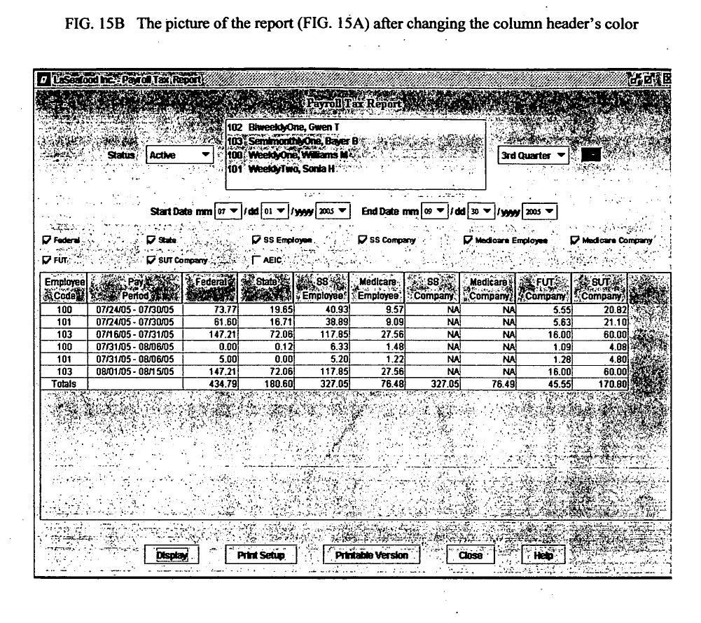

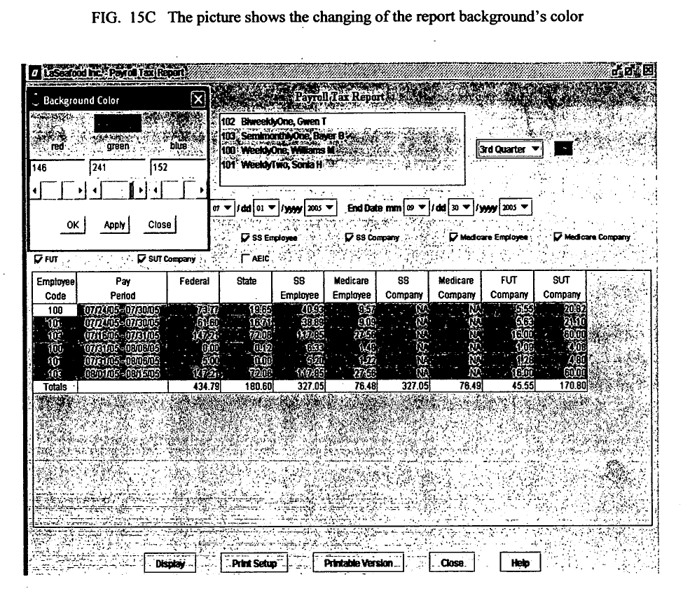

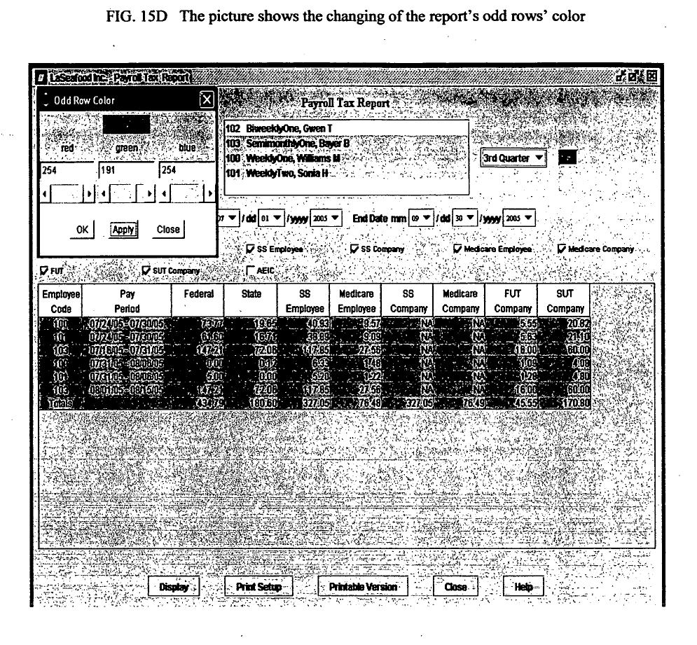

Changing the Column Header's Color: Referring to FIG. 15A, the report column header can be change dynamically by clicking on the color button and selecting the color from the popup color dialog. The column header's color of the report was changed as shown in FIG. 15B. The processes of changing the report's background color and odd rows color are the same (as shown in FIG. 15C and FIG. 15D).

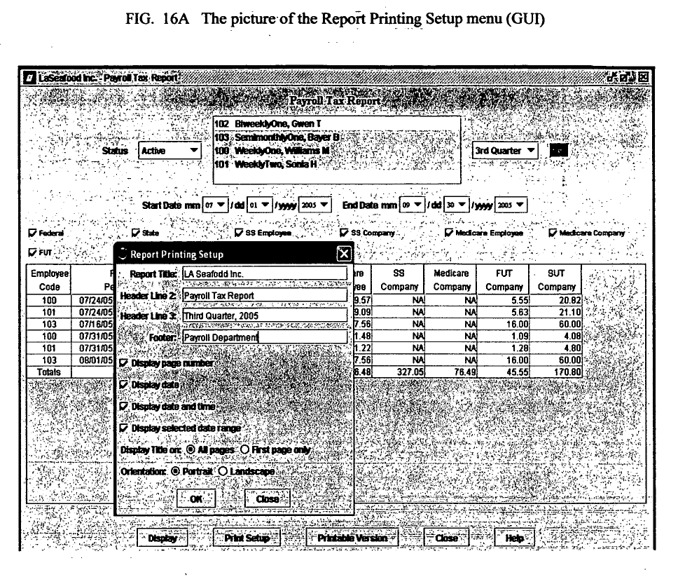

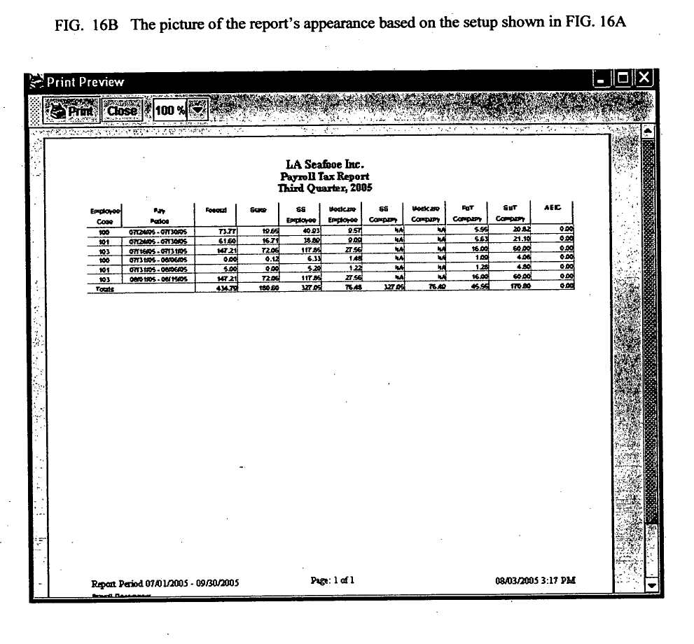

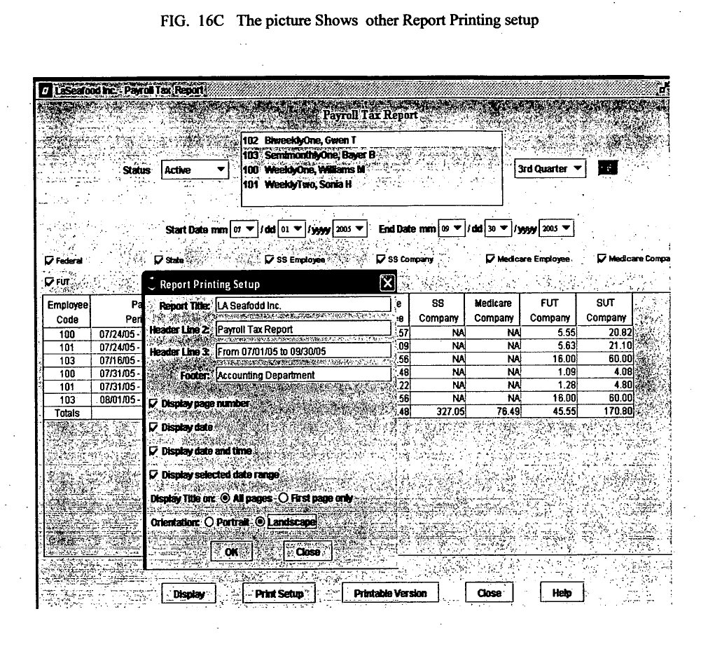

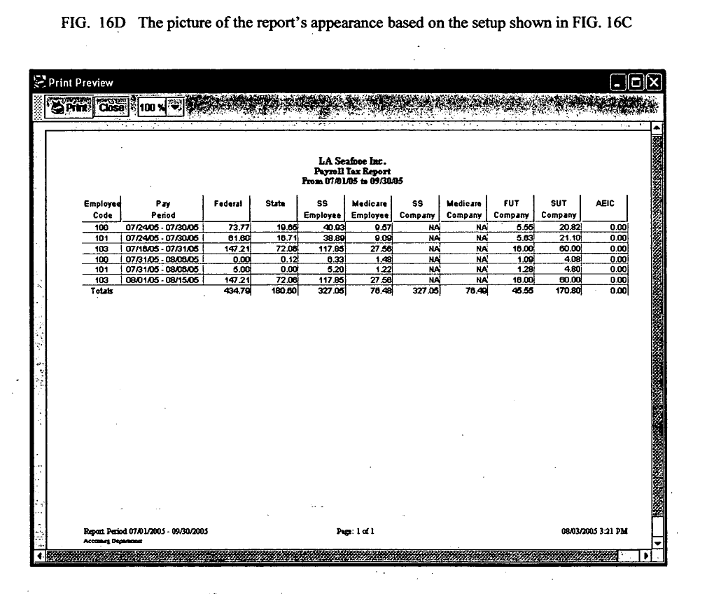

(3) Changing The Report Title: The system provides the Report Printing Set Up template (GUI) to change the report title's appearance. The procedure of changing as follows:
Select Print Setup button on the report menu to open the Report Printing Setup template (GUI);
Enter the data into the Report Printing Setup template as shown in FIG. 16A;
Click OK button, and then select the Printable Version button to view the print preview of the report (as shown in FIG. 16B).

Other report title setup is shown in FIG. 16C and FIG. 16D.

### A Single Fully Automated Payroll Data Processing PC Application Software Operating on Multiple PC GUI Worked Time Recorders Connected to a Single PC Server

Referring to FIG. 27, The invented PC application software, Single Fully Automated Payroll Data Processing System, can be configured to operate as multiple personal computer worked time recorders connected to a server, wherein the said multiple personal computer worked time recorders can directly write the employee worked time entries, recorded through the “clock in/clock out” process, into the said server's database.

### Conclusion

Although the above description has shown and pointed out the fundamental functions and the aspects of the invention as applied to the payroll system operable on a personal computer, those skilled in the art will recognize that many change or modifications may be made without departing from the spirit and scope of the invention as set forth in the claims appended hereto.

1. A single personal computer application payroll software, operating on a single personal computer, introduces the invented computerized payroll method that allows one to perform a complete payroll processing task without the need of an external worked time recorder and an intermediate data transferring device, by integrating the invented graphical user interface employee worked time recorder and the invented payroll data processing module into a single fully automated payroll data processing system which allows employee or authorized person to clock in/clock out employee worked times, and thence, the system automatically generates employee payroll checks, dynamic payroll reports, and payroll related tax forms, wherein the system is composed of:

2. An invented graphical user interface worked time recorder: which is an integral component of the said single fully automated payroll data processing system claimed in claim 1, which appears on a personal computer's screen having the capability to directly record employee worked time entries through “clock in/clock out” process into the system's database, wherein includes:
(a) a means for displaying and maintaining the current date and time;
(b) a means for displaying employees' codes, names, attendance status, and worked time entries;
(c) a means for employees to clock in and clock out their regular worked time or service worked time;
(d) a means for validating employee's “clock in” action by displaying the employee's “clock in” date-and-time and “clock in” status on the screen, or rejecting the duplicated or invalid “clock in” action by displaying an error message on the screen when the employee's current attendance status is “clock in”;
(e) a means for validating employee's “clock out” action by displaying the employee's “clock out” date-and-time and “clock out” status on the screen, or rejecting the duplicate or invalid “clock out” action by displaying an error message when the employee's attendance status is “clock out” or the employee's “clock in-clock out” time span is more than 24 hours;
(f) a means for employee to submit a brief note to the authorized person;
(g) a means for the authorized person to edit or correct employees' worked time entries.

3. The system of claim 1, wherein its internal time analyzing component reads directly employee worked time entry data, recorded by the graphical user interface employee worked time recorder of claim 2, from the system's database to analyze and categorize them into the worked-hour pay types such as regular, overtime, weekend, holiday, shift, service, etc., based on the employee's preset pay types and pay rules; and thence, automatically generates employee timesheets.

4. The system of claim 1, wherein its operating graphical user interface component includes:
(a) a means to enter company information, employee information, and the company's payroll related rules into the system's data base;
(b) a means to record employees' manual payment data, company's income data and non-payroll expense data into the system's data base;
(c) a means to view and print the employees' worked-time-entry reports at any time;
(d) a means to view and print the employees' timesheets at any time;
(e) a means to view and print the company payroll reports, which include employee worked-hour report, payroll-tax-liability report, Federal-tax-withheld report, state-and-local tax-withheld report, payroll-expense report, ,reported-tips report, uncollected-tax report, non-payroll-expense report, income report, profit-and-loss statement, etc., at any time;
(f) a means to view and print the payroll related tax forms which include Form 941, Form 940, Form 940-EZ, Form W-2, Form W-3, Form 1099-Misc, and Form 1096 at any time;
(g) a means to view and print employee payroll checks.

5. The system of claim 1, wherein its operating graphical user interface component allows one to customize on the fly the appearance of the generated report, which includes:
(a) a means for adding or removing the report's columns by selecting or deselecting the reporting payroll items displayed as check boxes on the report menu;
(b) a means for modifying dynamically the color of the report including header columns, background, total amount row, odd rows, even rows, and title by clicking on the color button and selecting the color from the popup color dialog;
(c) a means for setting the report title, page number, date-and-time, and footer by using the print-setup dialog menu.

6. The invented PC application software of claim 1 can be configured to operate as multiple personal computer worked time recorders connected to a server, wherein the said multiple personal computer worked time recorders can directly write the employee worked time entries, recorded through the “clock in/clock out” process, into the said server's database.
